(19) United States
(12) Patent Application Publication
(10) Pub. No.: US 2009/0135515 A1
(43) Pub. Date: May 28, 2009

(54) DISK APPARATUS AND INFORMATION RECORDING DISK

(75) Inventor: Hirosi SATOU, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/276,881

(22) Filed: Nov. 24, 2008

(30) Foreign Application Priority Data
Nov. 26, 2007 (JP) 2007-304582

(51) Int. Cl. G11B 21/02

(52) U.S. Cl. 360/75; G9B/21.003

(57) ABSTRACT

One aspect of the embodiments utilizes a disk apparatus employing a ramp loading method, which includes a ramp member having an overlapping portion with which a part of a disk having an information recording surface and a lateral side overlaps, and a groove is formed on the entire lateral side of the disk. The disk apparatus includes a protrusion formed on a portion of the overlapping portion of the ramp member that is opposed to the lateral side of the disk and the protrusion protrudes into the groove.

### CROSS-REFERENCE TO RELATED APPLICATION

This application is based upon and claims the benefit of priority to Japanese Patent Application No. 2007-304582, filed on Nov. 26, 2007, the entire contents of which are incorporated herein by reference.

### BACKGROUND

1. Field

The embodiments discussed herein are directed to a disk apparatus. More specifically, an aspect of the invention relates to a disk apparatus employing a ramp loading method for loading heads onto and unloading the heads from disks.

2. Description of Related Art

Hard disk drives (HDDs) are commonly used for computers as information recording apparatuses. Disk apparatuses, or the HDDs, read information from and write information onto disks with read/write heads. For the HDDs, the head is moved to a target position by an actuator with the head lifted above a recording surface of the disk that is spinning to read or write information.

While the HDD is not in operation, in brief, the disks do not spin, and the heads are retracted to a position other than the recording surface of the disk to prevent the heads from contacting the recording surfaces. There have been two methods to retract the heads: one is the contact start-stop (CSS) method; and the other is the ramp loading method. The CSS method provides a parking zone at an internal radius of the disk where information is not written, then stops the heads by abutting the heads against the parking zone. The ramp loading method provides a ramp outside of the disk and retracts the heads onto the ramp.

However, the CSS method has a disadvantage in that the disk and the head may deflect and crash upon an impact given externally. The head crash may damage the heads, deteriorating the head's read-write performance.

Whereas, with the ramp loading method, the head is retracted within the ramp while the disk does not spin. Hence the head does not crash against the disk. Therefore, the ramp loading method is a natural choice for disk apparatuses such as portable HDDs used in a condition having a high frequency of vibration.

Recently, magnetic disk apparatuses employing the ramp loading method used for portable devices such as laptop personal computers or music players have become smaller and thinner. As the devices and the players become more compact, clearances between recording surfaces of magnetic disks and ramps have become narrower.

When a shock or a vibration is given externally to the magnetic disk apparatus, magnetic disks may crash against the ramp due to play of the fixed parts of the magnetic disks fixed onto the spindle or deflection of the magnetic disks. In addition to external causes, the magnetic disks may contact the ramp due to wobble of the magnetic disks called fluttering that is caused by airflow generated within the magnetic disk apparatus by the spinning disks.

Due to contact and collisions between the magnetic disks and the ramp, the recording surfaces of the magnetic disks may be damaged. Additionally, the magnetic disks or the ramp may become worn and generate dust particles. If the dust particles collide with the heads, the heads may be damaged.

To surmount this problem, there is a technique in which a ramp is designed to have protrusions formed on overlapping portions with which the edges of disks may contact (Cf. Patent document 1). With this technique, recording surfaces of the disks do not contact the ramp when the disks wobble. Instead, the tapered edges of the disks contact the protrusions of the ramp first.

There have been other techniques in which a ramp is designed to have recesses formed on portions where the outermost edges of disks contact inner planes of the ramp, or where the outermost portions of the disks are tapered outwardly (Cf. patent document 2). This creates wider clearances between the disks and the ramp at those portions to keep the disks from contacting the ramp.

[Patent document 1] Japanese Laid-open Patent 2006-12405

[Patent document 2] Japanese Laid-open Patent 2006-323939

For the technique disclosed in patent document 1, dust particles may be generated where the chamfered edges of the disks contact the protrusions of the ramp. In this case, the dust particles may be generated in the vicinity of the recording surfaces of the disks, and hence the dust particles may spread over the recording surfaces, and collide against the heads.

For the technique disclosed in patent document 2, the disks may contact the ramp having the recesses therein to keep the outermost edges of the disk from contacting the ramp where the disks deflect greatly. Even if the outermost edges of the disks are tapered, the ramp may contact the disks with portions not tapered where the disks deflect the most. As the clearances between the disks and the ramp in the overlapping portions become narrower, inevitably, the disks may contact the ramp.

The technique disclosed in the present embodiment is provided to address the problems mentioned above. An object of the embodiment is to provide the disk apparatus and the disk with which the recording surface of the disk may not be damaged due to contact with the ramp, and if dust particles are generated on the contact, the dust particles may not collide against the head.

### SUMMARY

In keeping with one aspect of an embodiment of this technique, a disk apparatus employing a ramp loading method includes a ramp member having an overlapping portion with which a part of a disk having an information recording surface and a lateral side overlaps, and a groove formed on the entire lateral side of the disk. The ramp includes a protrusion formed on a portion of the overlapping portion of the ramp member that is opposed to the lateral side of the disk, and the protrusion protrudes into the groove.

Additional objects and advantages of the embodiments will be set forth in part in the description which follows, and in part will be obvious from the description, or may be learned by practice of the embodiment. The object and advantages of the embodiment will be realized and attained by means of the elements and combinations particularly pointed out in the appended claims.

It is to be understood that both the foregoing general description and the following detailed descriptions are exemplary and explanatory only and are not restrictive of the embodiment, as claimed.

### BRIEF DESCRIPTION OF THE DRAWINGS

FIG. 1 is a plan view of the hard disk drive;

FIG. 2 illustrates the ramp member and the periphery thereof;

FIG. 3 is a perspective view of the ramp member and the periphery;

FIG. 4 is a sectional view briefly illustrating the ramp member in which the magnetic disk is inserted; and

FIG. 5 is a sectional view of the magnetic disk having rectangular-shaped groove on its lateral side.

### DESCRIPTION OF THE PREFERRED EMBODIMENTS

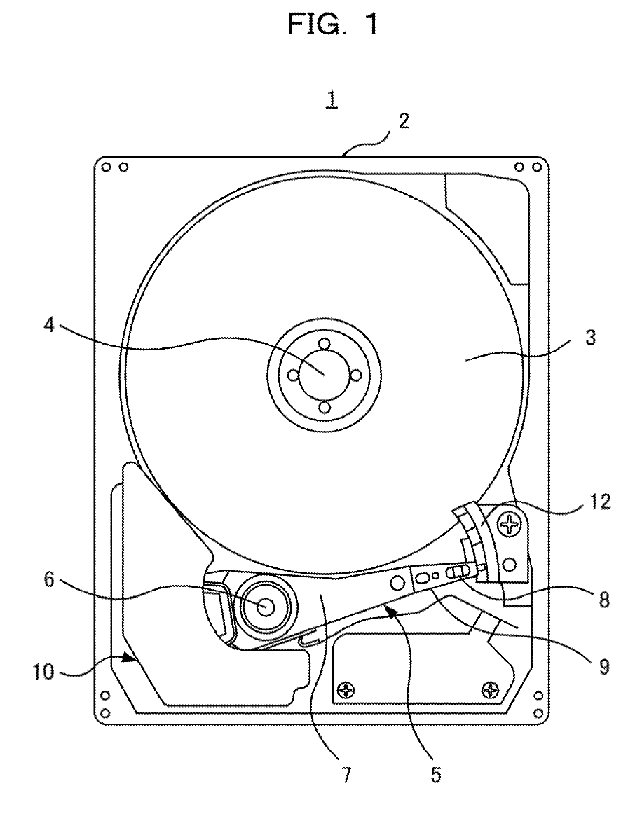

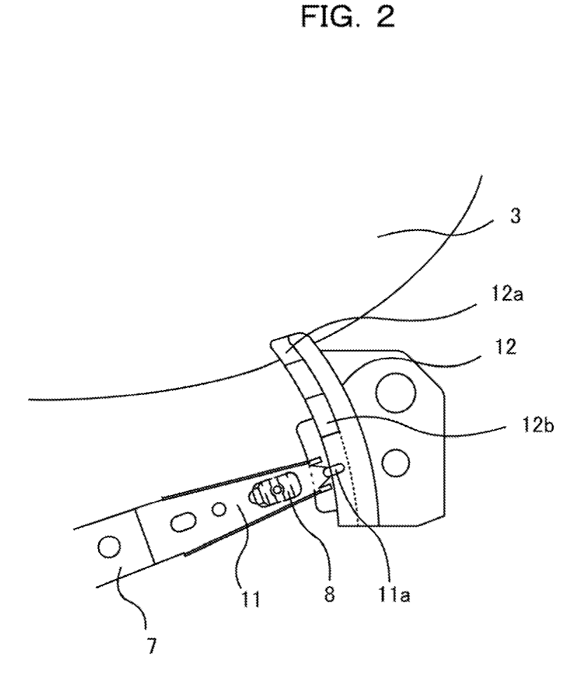

Referring to FIGS. 1 and 2, a structure of the disk apparatus in an embodiment of the present technique, a hard disk drive, will be disclosed. FIG. 1 is a brief plan view illustrating the interior of the hard disk drive. FIG. 2 is an enlarged plan view of the ramp member and the periphery shown FIG. 1.

A hard disk drive 1 has an enclosure 2 in a box-shape, having a flat rectangular solid space therein. The enclosure 2 accommodates one or more magnetic disks 3 therein as information recording disks. The magnetic disks 3 are mounted onto a rotary shaft of a spindle mortar 4. The spindle mortar 4 rotates the magnetic disks 3 at high speed, for example, 7,200 rpm or 10,000 rpm. The enclosure 2 has a lift, or a cover, not shown in FIG. 1, with which the internal space is sealed within the enclosure 2 and the cover.

Within the enclosure 2, carriages 5 whose tips are opposed to the recording surfaces of the magnetic disks 3 are accommodated. The carriage 5 has swing arms 7 which rotate about a spindle 6 and suspension arms 9 attached to the ends of the swing arms 7 supporting each of the head sliders 8 at their tips. The swing arms 7 are driven by an electromagnetic actuator 10 such as a voice coil mortar (VCM). As the swing arms 7 moves, the head sliders 8 traverse the magnetic disks 3 in a radial direction. Thus, a head slider 8 is positioned on a targeted recording track of the magnetic disk 3. Typically, on both sides of the swing arm 7, two head sliders 8 and therefore two head suspensions 9 are attached so as to be opposed to the neighboring magnetic disks 3 where a plurality of the magnetic disks 3 is mounted in the enclosure 2.

The load beams 11 are attached to the tips of the suspension arms 9 that are attached to the ends of the carriages 5, extending forward from the suspension arms 9. As the swing arms 7 move, the load beams 11 move together with the head sliders 8 in the radial direction of the magnetic disks 3.

Near the magnetic disks 3, a ramp member 12 is provided on a path of the load beam 11 movement. When the head sliders 8 reach the rims of the magnetic disks 3, load beam tips 11a of the load beams 11 slide on slopes 12a provided on the ramp member 12. As the load beams 11 move away from the magnetic disks further, the load beam tips 11a of the load beams 11 slide up the slopes 12a gradually, and therefore the head sliders 8 are distanced from the magnetic disks 3. After sliding up the slopes 12a, the load beam tips 11a of the load beams 11 moving in the radial direction outward are withdrawn into the recesses 12b and then stop. In this way, the head sliders 8 are retracted, and kept from contacting the magnetic disks 3 while the magnetic disks 3 do not spin. When the head sliders 8 move toward the magnetic disks 3, the load beams 11 move in the radial direction of the magnetic disks 3 inward, sliding down the slopes 12a with the load beam tips 11a of the load beams 11. Finally, the load beam tips 11a lift off the slopes 12a and the head sliders 8 are positioned over the magnetic disks 3. Since the magnetic disks 3 spin at high speed while the heads is moving, the head sliders 8 are lifted with the airflow generated by the spinning magnetic disks 3. As described above, a load-unload system is implemented by the load beams 11 and the ramp member 12.

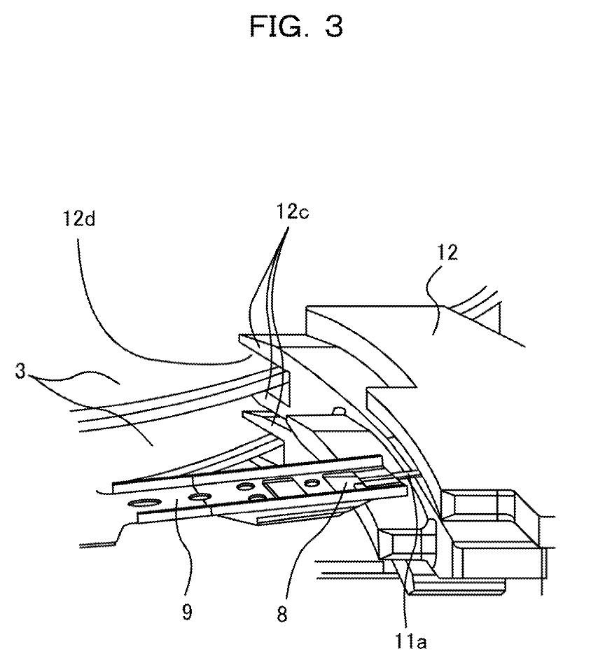

FIG. 3 is the perspective view of the ramp member and the periphery. For simplification, only one of the suspension arms 9 is drawn in FIG. 3. The ramp member 12 has end portions 12c protruding over and under the outermost portions of the magnetic disks 3 so as to sandwich the disks. An overlapping portion 12d is formed between a pair of the end portions 12c. In other words, the magnetic disks 3 are rotatably supported with their edges inserted in the overlapping portions 12d. The portion near the edge is an area where no information is recorded. Thus, the head sliders 8 with magnetic heads fly over the recording surfaces of the magnetic disks 3 when the load beam tips 11a of the load beams 11 slide down the slopes 12a provided for the ramp member 12 and move away from the ramp member 12.

The ramp member 12 is typically made of resin, more specifically, a polyacetal resin whose coefficient of friction is low such as delrin. In general, the magnetic disk 3 is made of, from bottom to top, an aluminum or glass substrate, an underlayer, a magnetic layer, a protective layer, and a lubricant layer.

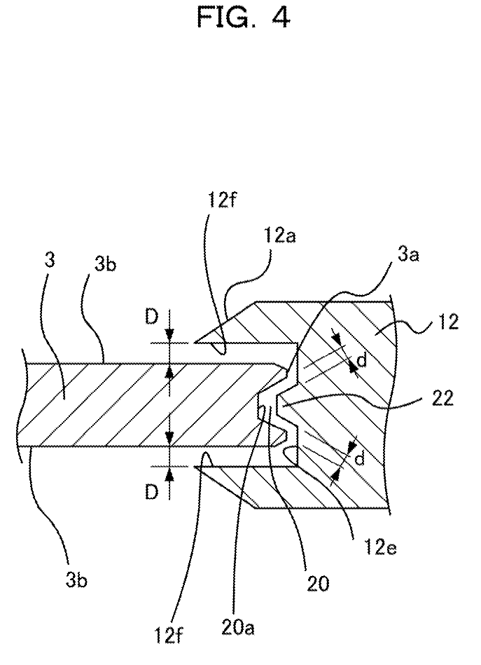

In this embodiment, the grooves are formed on the lateral sides of the magnetic disks 3 circumferentially so that the protrusions formed in the overlapping portions 12d of the ramp member 12 protrude into the groove. The grooves and the protrusions will be disclosed with reference to FIG. 4. FIG. 4 is the sectional view illustrating briefly the ramp member 12 in which the rim of the magnetic disk 3 is inserted.

As described above, grooves 20 are formed on the lateral sides 3a of the magnetic disks 3 circumferentially without discontinuity. The grooves are formed in a tapered shape, viewed from the lateral side, gradually inclining inward, having flat bottom planes 20a.

The bottom planes 12e of the overlapping portions 12d are opposed to the lateral sides 3a of the magnetic disks 3 with only a slight clearance therebetween.

In the middle of the bottom plane 12e of the overlapping portion 12d, a protrusion 22 that protrudes toward the groove 20 formed on the lateral side of the magnetic disk 3 is formed. Similar to the groove 20, the profile of the protrusion 22 is in a tapered shape. Between the groove 20 and the side surfaces of the protrusion 22, a clearance of a given dimension d is provided.

The dimension D clearance between the magnetic disk 3 and the inner surfaces 12f of the overlapping portion 12d is greater than the dimension d of the clearance between the inner sides of the groove 20 and the side planes of the protrusion 22. Thus, the dimensions are D>d. As a result, the inside of the groove 20 formed on the lateral side of the magnetic disk 3 contacts the protrusion 22 if the magnetic disk 3 deflects or tilts to prevent the magnetic disk from deflecting or tilting further. Since the magnetic disk 3 cannot deflect or tilt further, a recording surface 3b of the magnetic disk 3 does not contact the ramp member 12. Thus, the recording surface 3b of the magnetic disk 3 is kept from suffering damages.

In the case where the thickness of the magnetic disk 3 ranges from 0.7 mm to 1.8 mm, the width of the portion of the magnetic disk 3 that is overlapped by the overlapping portion 12d of the ramp member 12 may be, for example, 1 mm. In this instance, the rim of the magnetic disk 3 1.2 mm to 1.3 mm inside from the lateral side 3a is the non-recording area, and the area inside the non-recording area is the recording area. Where the dimension D is 0.2 mm and the dimension d is 0.05 mm to 0.1 mm, D>d is satisfied. Thus, the deflection and the tilt of the magnetic disk 3 are prevented effectively.

Typically, the recording surface 3b of the magnetic disk 3 is coated with lubricant to reduce possible friction with the head slider to prevent damages to the magnetic disks 3. In this embodiment, the lubricant is coated inside the grooves 20 and on the internal surfaces including the bottom planes. The lubricant reduces friction even if contact between the protrusion 22 and the inner surfaces of the groove 20 occurs. Thus, the protrusion 22 slides inside of the groove 20 smoothly. Therefore, damages to the contact portions and the generation of dust particles may be reduced.

If dust particles are generated by contact with the groove 20 and the protrusion 22, the dust particles may attach to the inner surfaces of the groove 20 on which the lubricant is coated. Thus, the dust particles may not gather over the recording surface 3b of the magnetic disk 3, and collisions against the head slider or the magnetic head are prevented.

Accordingly, the magnetic disk drive in this embodiment of the present technique prevents the deflection and tilt of the magnetic disk due to the vibration or shock, and therefore the damages to the recording surface 3b of the magnetic disk 3 may be reduced. Additionally, the magnetic disk 3 may contact the ramp member 12 with its groove 20 formed on the lateral side 3a, not on the recording surface 3b. Thus, the dust particles may not spread over the recording surface 3b, and so collisions with the magnetic head are reduced. Accordingly, a dust-resistant magnetic disk drive may be achieved.

The profile of the groove 20 and the protrusion 22 are formed in a tapered shape. As such, the bottom basal portion of the protrusions 2 is thicker than its top portion, obtaining an increased strength. Since there is a possibility that the protrusion 22 contacts the magnetic disk 3, the protrusion may be broken on contact if adequate strength is not ensured. In terms of shock-resistance, the tapered protrusion 22 is resistant to impacts because its basal portion is thicker. The angles of the tapered portions may be determined based on shapes or dimensions of the magnetic disk 3 or the ramp member.

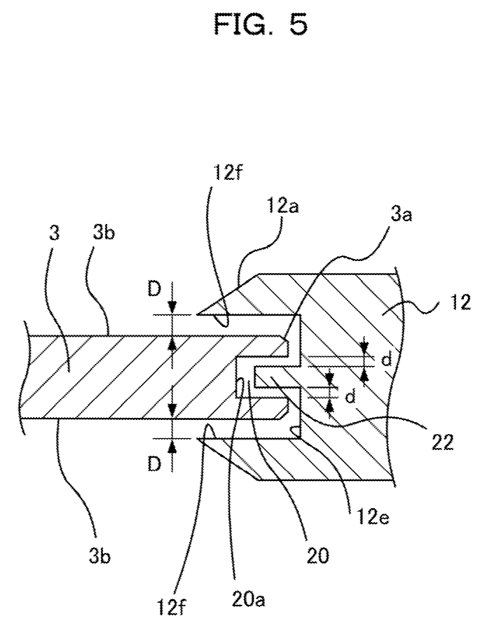

However, the profiles of the groove 20 and the protrusion 22 are not to be considered limited to the tapered shape as shown in FIG. 4. Alternatively, the profiles may be a rectangular shape as shown in FIG. 5. The inner surfaces of the groove 20 and the bottom plane 20a and the side surfaces and the top of the protrusion 22 are not necessarily flat, but may also be curvilinear.

Where the profiles of the groove 20 and the protrusion 22 are formed in a rectangular shape, the protrusion may be extended to an allowable length in strength to increase the area of the side surfaces of the protrusion 22 that contacts the inner surfaces of the groove 20. As the contact area increases, contact pressure per unit area decreases. The more friction between the disk 3 and the ramp member 12 is reduced, the more the dust particles decrease.

In this embodiment, the magnetic disk drive is disclosed as a disk apparatus. However, this technique is applicable not only to magnetic disk apparatuses, but also to magneto-optical disk apparatuses or optical disk apparatuses. In other words, the technique disclosed in this application may be applicable not only to magnetic disks but also to information recording disks, for example, magneto-optical disks and optical disks.

According to this technique, the recording surface of the disk may not contact the ramp member because the protrusion formed in the ramp member keeps the recording surface of the disk from contacting the ramp member. Further, if the protrusion of the ramp member contacts the inner surfaces of the groove and the dust particles are generated, the dust particles may stay in the groove. Therefore, dust collisions between the recording area and the head may be reduced. Accordingly, a vibration-proof and shock-resistant disk apparatus may be accomplished.

Although the embodiments of the present inventions have been described in detail, it should be understood that the various changes, substitutions, and alterations could be made hereto without departing from the spirit and scope of the invention.

What is claimed is:

1. A disk apparatus employing a ramp loading method, comprising:
a ramp member having an overlapping portion with which a part of a disk having an information recording surface and a lateral side overlaps;
a groove formed on the entire lateral side of the disk;
a protrusion formed on a portion of the overlapping portion of the ramp member that is opposed to the lateral side of the disk, the protrusion protruding into the groove.

2. The disk apparatus according to claim 1, wherein a certain clearance is left between the protrusion and the groove.

3. The disk apparatus according to claim 2, wherein a dimension of the certain clearance is narrower than a clearance between the information recording surface of the disk and an inner surface of the overlapping portion of the ramp member.

4. The disk apparatus according to claim 1, wherein a profile of the groove is in a tapered shape; and a profile of the protrusion is also in a tapered shape.

5. The disk apparatus according to claim 1, wherein a profile of the groove is in a rectangular shape; and a profile of the protrusion is also in a rectangular shape.

6. The disk apparatus according to claim 1, wherein lubricant is coated on an inner wall of the groove.

7. An information recording disk that is incorporated in a disk apparatus, comprising:
a groove formed on a lateral side thereof entirely.

8. The information recording disk according to claim 7, wherein a profile of the groove is in a tapered shape.

9. The information recording disk according to claim 7, wherein a profile of the groove is in a rectangular shape.
